(19) United States
(12) Patent Application Publication
(10) Pub. No.: US 2014/0374401 A1
(43) Pub. Date: Dec. 25, 2014

(54) AUTOMOTIVE GLAZING AND METHOD OF MANUFACTURING SAME

(71) Applicant: Nippon Sheet Glass Co., Ltd., Tokyo (JP)

(72) Inventor: MASAFUMI NAKAGAWA, Muko-shi (JP)

(73) Assignee: Nippon Sheet Glass Co., Ltd., Tokyo (JP)

(21) Appl. No.: 14/303,850

(22) Filed: Jun. 13, 2014

(30) Foreign Application Priority Data
Jun. 20, 2013 (JP) 2013-129308

(51) Int. Cl. H05B 3/86; B32B 37/16; B32B 37/12; B60J 1/00; H05B 3/04

(52) U.S. Cl. CPC H05B 3/86; B60J 1/001; H05B 3/04; B32B 37/1284; B32B 37/16; B32B 2307/7265; B32B 2605/006
USPC 219/203; 156/305

(57) ABSTRACT

In an automotive glazing comprising a laminated glazing sheet (2) including a first glazing sheet (6), a second glazing sheet (8) laminated to an outboard side of the first glazing sheet and an electric device (13) placed between the first and second glazing sheets, and a seal member (4) attached to a peripheral part of the laminated glazing sheet, a cutout (11) is formed in a peripheral part of the first glazing sheet, and a support member (24) defining an inboard surface (26) flush with an inboard side of the first glazing sheet is placed in the cutout. Terminal pieces (17) are drawn from electrode pieces (12) of the electric device out of the cutout via a gap defined between an edge of the first glazing sheet defining the cutout and an opposing edge of the support member. The terminal pieces include free end parts bonded to the corresponding electrode pieces and drawn away from an adjoining peripheral part of the second glazing sheet, and base end parts bent back toward the peripheral part of the second glazing sheet and extending along an inboard side of the seal member.

### BACKGROUND OF THE INVENTION

The present invention relates to an automotive glazing incorporated with an electro-conductive pattern and a method of manufacturing the same.

An automotive glazing such as an automotive windscreen is typically fitted with an elastomeric seal member attached to the periphery of a glazing sheet such as a glass sheet, and the seal member is attached to a vehicle panel so that the glazing sheet may be attached to the vehicle body in a water tight manner. Such a seal member is formed along the edge of the glazing sheet by insert molding or molded separately and attached to the edge of the glazing sheet by using a bonding agent or an adhesive tape as disclosed in JP2003-532574A. The seal member disclosed in JP2003-532574A includes a plate member extending along the periphery of the inboard side of the glazing sheet. The plate member is bonded to the periphery of the inboard side of the glazing sheet by using two-sided tape. The seal member includes a portion that engages a part of a water box cover formed between the lower edge of the glazing sheet and the rear end of an engine hood such that the water box cover is enclosed.

When the glazing sheet consists of a laminated glazing sheet consisting of an outboard glazing sheet and an inboard glazing sheet, and an electric device is formed between the two glazing sheets, a cutout may be formed in a peripheral edge of the inboard glazing sheet to place the electrodes of such a device. In such a case, attachment of a seal member to the inboard glazing sheet is interrupted by the cutout. Also, as the lead wires that are connected between the electrodes and an external power source may interfere with the seal member, an appropriate positioning of the seal member may be prevented.

### SUMMARY OF INVENTION

In view of such problems of the prior art, a primary object of the present invention is to provide an automotive glazing incorporated with an electric device such as a deicer which allows a seal member to be attached to a peripheral part of the glazing in a favorable manner.

A second object of the present invention is to provide an automotive glazing incorporated with an electric device such as a deicer which can ensure favorable sealing of electrodes or terminals of the electric device.

A third object of the present invention is to provide a method of manufacturing such an automotive glazing.

The present invention achieves such objects by providing an automotive glazing, comprising a laminated glazing sheet including a first glazing sheet and a second glazing sheet laminated to an outboard side of the first glazing sheet, and a seal member attached to a peripheral part of the laminated glazing sheet, the automotive glazing further comprising: a cutout formed in a peripheral part of the first glazing sheet; an electro-conductive pattern formed on an inboard side of the second glazing sheet; electrode pieces connected to parts of the electro-conductive pattern and placed on the inboard side of the second glazing sheet within the cutout of the first glazing sheet; flexible terminal pieces bonded to the corresponding electrode pieces; and a cover member placed in the cutout so as to at least partly cover the electrode pieces and associated parts of the terminal pieces and defining an inboard surface substantially flush with an inboard side of the first glazing sheet; wherein the seal member is bonded to a peripheral part of the inboard side of the first glazing sheet and the inboard surface of the cover member, and the terminal pieces are drawn from the electrode pieces out of the cutout via the cover member.

Thereby, the terminal pieces can be drawn out from the cutout without being interfered by the seal member. As the terminal pieces are flexible, they can be bent and drawn in any desired direction. Preferably, the terminal pieces are drawn from the electrode pieces out of the cutout via a part of the cover member adjacent to an edge of the first glazing sheet defining the cutout.

According to a particularly preferred embodiment of the present invention, the terminal pieces include free end parts bonded to the corresponding electrode pieces and drawn away from an adjoining peripheral part of the second glazing sheet, and base end parts bent back toward the peripheral part of the second glazing sheet and extending along an inboard side of the seal member.

The terminal pieces can be held in a mechanically stable condition when parts of the terminal pieces drawn out from the cutout are bonded to an inboard side of the first glazing sheet before being bent back. In particular, the movement of the terminal pieces relative to the sealant can be effectively avoided so that the sealing performance of the sealant is ensured.

According to a certain aspect of the present invention, the cover member comprises a support member bonded to the inboard side of the second glazing sheet and defining the inboard surface of the cover member, and a sealant covering parts of the terminal pieces that are connected to the electrode pieces.

As the support member that is bonded to the inboard side of the second glazing sheet defines the inboard surface of the cover member, the inboard surface of the cover member for bonding the seal member can be maintained in a highly controlled condition so that the seal member can be bonded to the cover member in a mechanically favorable condition.

According to another aspect of the present invention, the support member comprises a projection abutting the inboard side of the second glazing sheet and a recess defining a gap between a main part of the support member and the inboard side of the second glazing sheet, at least parts of the electrode pieces and the terminal pieces being placed in the gap defined between the main part of the support member and the inboard side of the second glazing sheet.

Thereby, the support member can be placed on the inboard side of the second glazing sheet without being interfered by the electrode pieces and the terminal pieces. In particular, even when the cutout is relative small, and the electrode pieces occupy a relatively area on the inboard side of the second glazing sheet within the cutout, the support member can be placed in the cutout without being interfered by the electrode pieces and the terminal pieces.

According to yet another aspect of the present invention, the support member includes an outer edge extending along a peripheral edge of the second glazing sheet, a pair of lateral edges abutting respective lateral edges of the first glazing sheet defining the cutout and an inner edge spaced from an opposing edge of the first glazing sheet defining the cutout.

In this case, the terminal pieces can be drawn out of the cutout via the gap defined between the inner edge of the support member and the opposing edge of the first glazing sheet defining the cutout.

Preferably, the gap defined between the inner edge of the support member and the opposing edge of the first glazing sheet is at least partly filled by the sealant.

As the sealant is filled into the part of the cutout which is enclosed along the entire side thereof, the sealant can be favorable shaped, and held in the given shape without requiring any additional components.

According to yet another aspect of the present invention, an inboard surface of the sealant filling the gap defined between the inner edge of the support member and the opposing edge of the first glazing sheet is substantially flush with the inboard surface of the support member and the inboard side of the first glazing sheet.

According to this arrangement, even when the seal member is to be bonded to the inboard surface of the sealant, a favorable bonding can be achieved between the sealant and the sealing member.

According to yet another aspect of the present invention, the seal member includes a bonded part which is bonded to the peripheral part of the inboard side of the first glazing sheet and the inboard surface of the support member. In this case, a particularly favorable bonding between the seal member and the cover member can be achieved.

Preferably, the terminal pieces are fixedly attached to a spacer bar which is in turn bonded to an inboard side of the bonded part of the seal member. Thereby, the terminal pieces can be held in place in an even more stable manner.

The present invention also provides a method of manufacturing an automotive glazing, comprising the steps of preparing a laminated glazing sheet including a first glazing sheet having a cutout formed in a peripheral part thereof, a second glazing sheet laminated to an outboard side of the first glazing sheet, an electro-conductive pattern formed on an inboard side of the second glazing sheet, electrode pieces connected to parts of the electro-conductive pattern and placed on the inboard side of the second glazing sheet within the cutout of the first glazing sheet; bonding an end of a flexible terminal piece to each of the electrode pieces, and drawing another end of the terminal piece out of the cutout; depositing a sealant in the cutout so as to at least partly cover the electrode pieces and corresponding parts of the terminal pieces; placing a support member in the cutout before the sealant has cured such that the support member defines a support surface substantially flush with the inboard side of the first glazing sheet; and attaching a seal member to an inboard side of a peripheral part of the first glazing sheet and the support surface of the support member.

According to this method, the surface for bonding the sealing member in the cutout can be created in a highly precise manner without requiring any complex or costly arrangement.

The automotive glazing of the present invention allows an electric device such as a deicer to be incorporated therein and a seal member to be mounted on the periphery thereof in a favorable manner.

### BRIEF DESCRIPTION OF DRAWINGS

Now the present invention is described in the following with reference to the appended drawings, in which:

FIG. 1 is an exploded view of an automotive glazing in the form of an automotive front windscreen embodying the present invention as seen from inside the vehicle;

FIG. 2 is a fragmentary enlarged view of a part of FIG. 1 with a seal member omitted from illustration;

FIG. 3 is a sectional view taken along line III-III of FIG. 2;

FIG. 4 is a sectional view taken along line IV-IV of FIG. 2;

FIG. 5 is a perspective view of an end part of a wire harness;

FIG. 6a is a front perspective view of a support member;

FIG. 6b is a rear perspective view of the support member;

FIG. 7 is a sectional view showing an early stage of manufacturing the automotive front windscreen according to the present invention;

FIG. 8 is a sectional view showing an intermediate stage of manufacturing the automotive front windscreen according to the present invention;

FIG. 9 is a sectional view showing a late stage of manufacturing the automotive front windscreen according to the present invention;

FIG. 10a is a front perspective view of a modified embodiment of the support member; and

FIG. 10b is a rear perspective view of the support member.

### DETAILED DESCRIPTION OF THE INVENTION

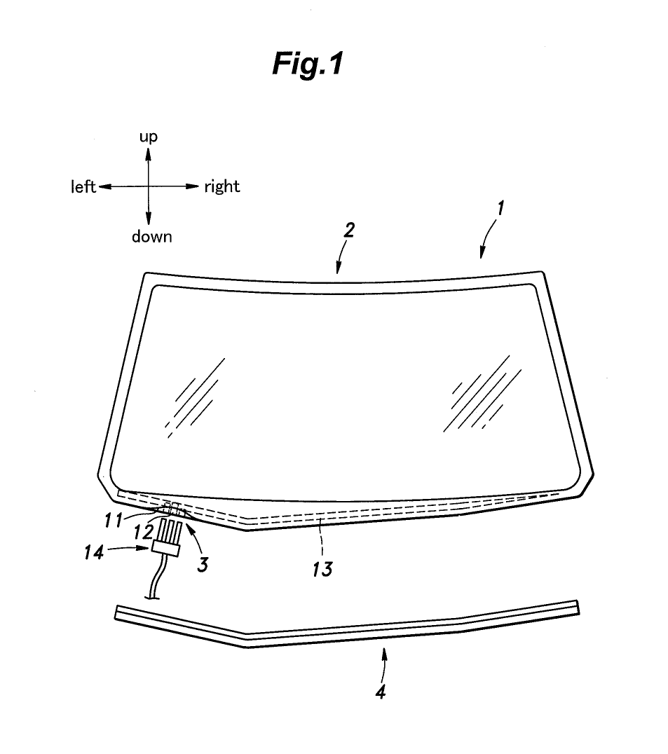

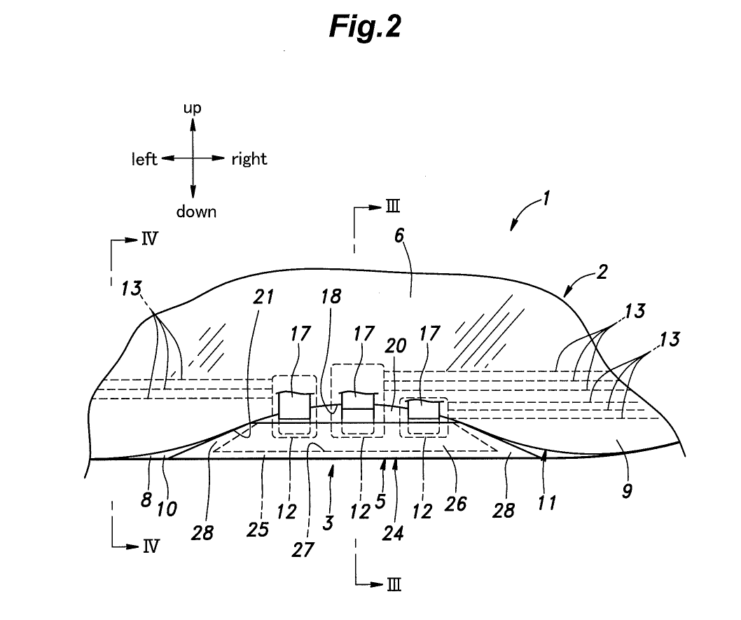

FIG. 1 is an exploded view of an automotive glazing in the form of an automotive front windscreen embodying the present invention as seen from inside the vehicle, and FIG. 2 is a fragmentary enlarged view of a part of FIG. 1 with a seal member omitted from illustration.

Referring to FIGS. 1 and 2, this windscreen 1 comprises a laminated glass sheet 2 incorporated with a deicer 3 therein, and a seal member 4 attached to the peripheral edge of the laminated glass sheet 2.

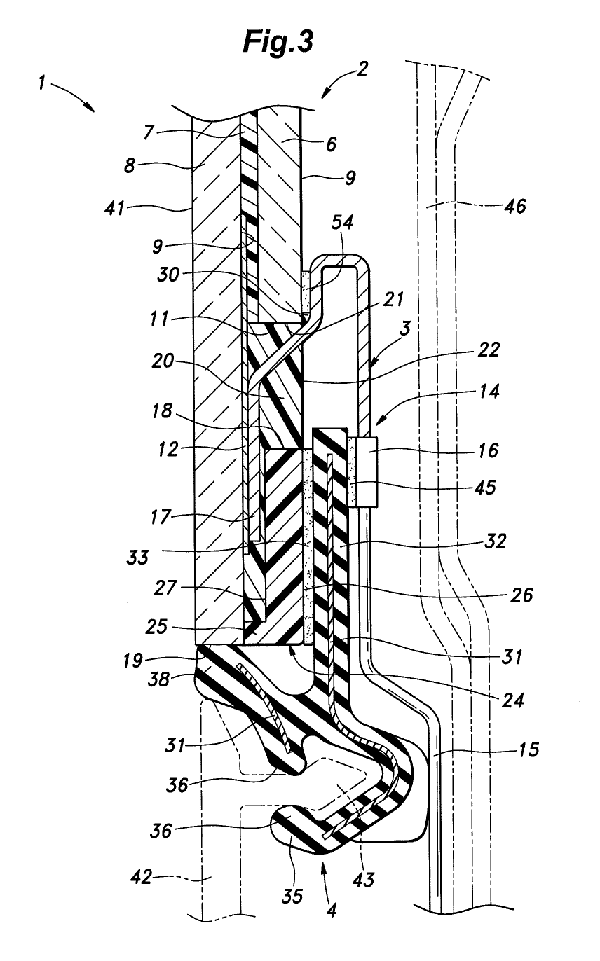

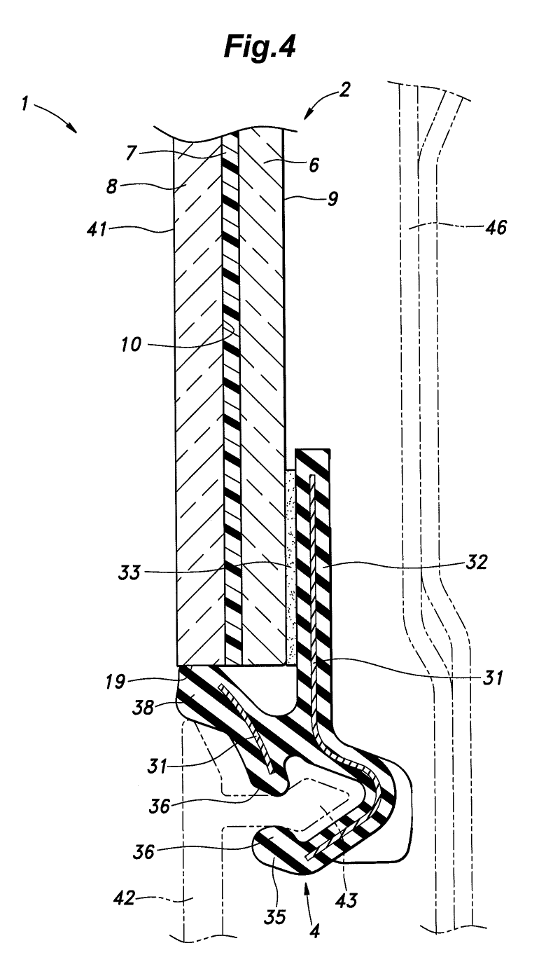

FIG. 3 is a sectional view taken along line of FIG. 2, and FIG. 4 is a sectional view taken along line IV-IV of FIG. 2. Referring to FIGS. 3 and 4, the laminated glass sheet 2 comprises a first glass sheet 6 positioned on the inboard side thereof, and a second glass sheet 8 laminated to the first glass sheet 6 on the outboard side via an interlayer 7. The first and second glass sheets 6 and 8 may consist of normal float glass sheets, and the interlayer 7 may consist of a transparent plastic film such as a polyvinyl butyral (PVB) film However, other glazing sheets such as transparent plastic sheets may also be used, instead of the glass sheets 6 and 8. In the following description, the surface of the first glass sheet 6 facing inboard is referred to as a first surface 9, and the surface of the second glass sheet 8 facing inboard is referred to as a second surface 10.

The first glass sheet 6 is provided with a cutout 11 in a lower edge thereof. The cutout 11 is passed through the thickness of the first glass sheet 6, and is provided with the shape of a segment of a circle in plan view. Either lateral end of the cutout 11 is curved with a curvature of an opposite sense to the main part of the cutout 11 so as to smoothly connect with the linear lower edge of the remaining part of the first glass sheet 6. The interlayer 7 is also cut out in conformity with the cutout 11 so that the second surface 10 of the second glass sheet 8 is exposed in the cutout 11.

The cutout 11 is filled by a cover 5 conformal to the cutout 11. The cover 5 includes a support member 24 covering a lower part of the cutout 11 and made of a relatively stiff material, and a sealant 20 filling an upper part of the cutout 11 which is not covered by the support member 24.

A plurality of bus bars (electrode pieces) 12 are formed on the second surface 10 of the second glass sheet 8 such that a part of each bust bar 12 is interposed between the first and second glass sheets 6 and 8 while a remaining part thereof is exposed in the cutout 11. A plurality of electro-conductive strips 13 are formed on the second surface 10 of the second glass sheet 8, and are connected to the bus bars 12 in a prescribed combination as will be discussed hereinafter. Three bus bars 12 are formed on the second glass sheet 8 in the illustrated embodiment, but two, four or more bus bars may also be formed without departing from the spirit of the present invention. The bus bars 12 and the electro-conductive strips 13 are formed by printing and curing silver paste on the second surface 10 of the second glass sheet 8, and are electro-conductive. The bus bars 12 and the electro-conductive strips 13 are formed on the second surface 10 of the second glass sheet 8 before the first glass sheet 6 is joined to the first glass sheet 6 via the interlayer 7.

Each bus bar 12 is connected to an end of a wire harness 14 provided on the vehicle for the distribution of electric power so that the electro-conductive strips 13 can be heated by supplying electric power thereto via the wire harness 14. Thus, the laminated glass sheet 2 can be heated by the electro-conductive strips 13.

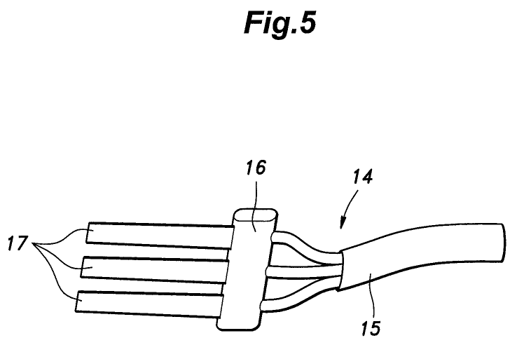

FIG. 5 is a perspective view of the wire harness 14. Referring to FIG. 5, the wire harness 14 comprises a main cable portion 15 including a bundle of wires and having a circular cross section. One end of the main cable portion 15 is separated into three branch wires which are fixed relative to each other in a mutually spaced part relationship by a spacer bar 16 made of electrically insulating material. Three terminal pieces 17 extend from the spacer bar 16, and are electrically connected to the corresponding three branch wires inside the spacer bar 16. Each terminal piece 17 includes an electro-conductive metallic strip and an electrically insulating sheath that covers the metallic strip. The metallic strip may be made of metal or alloy such as copper and aluminum, and is give with a small thickness so as to be flexible. The sheath may be made of plastic material such as polyimide. In the illustrated embodiment, each terminal piece is made of a widely available flexible printed circuit board.

The terminal pieces 17 are fixedly secured to the spacer bar 16 such that the terminal pieces 17 extend parallel to one another, and the major surfaces thereof extend in a common plane. The spacer bar 16 is formed by molding plastic material, and encapsulates the base ends of the terminal pieces 17 therein. The terminal pieces 17 are electrically connected to the corresponding wires of the main cable portion 15 inside the spacer bar 16.

As shown in FIGS. 3 and 4, each terminal piece 17 is bonded to the corresponding bus bar 12 such that the major surface of the terminal piece 17 is laid over the outer surface of the bus bar 12. This bonding may be achieved by any per se known method, such as soldering, brazing, welding, adhesion by using electro-conductive tape. The bonding is achieved by removing any plastic layer or any other film from the surfaces of the two metallic parts (terminal piece 17 and bus bar 12). When the terminal piece 17 and the bus bar 12 are soldered to each other, the heat for the soldering process melts away the plastic film that may otherwise intervene between the surfaces of the two metallic parts (terminal piece 17 and bus bar 12).

As shown in FIG. 3, the spacer bar 16 is attached to an inboard surface of a part of the seal member 4 (as will be described hereinafter) by using two-sided tape 45 such that the terminal pieces 17 extend upward therefrom, and the wires of the cable portion 15 of the wire harness 14 extend downward therefrom. Each terminal piece 17 is bent back (by about 180 degrees) in the outboard direction at an intermediate point thereof, and the base end of the bent back part (adjacent to the 180 degree bend) is attached to the first surface 9 of the first glass sheet 6 by using two-sided tape 54. The terminal piece 17 then extends obliquely downward into the cutout 11 of the first glass sheet 6, and the terminal (free) end of the terminal piece 17 is bonded to the bus bar 12 with the terminal edge of the terminal piece 17 directed downward.

In other words, the terminal pieces 17 are drawn from the bus bars 12 out of the cutout 11 via a gap defined between an edge of the first glass sheet 6 defining the cutout 11 and an opposing edge of the support member 24. The terminal pieces 17 include free end parts bonded to the corresponding bus bars 12 and drawn away from an adjoining peripheral part of the second glass sheet 8, and base end parts bent back toward the peripheral part of the second glass sheet 8 and extending along an inboard side of the seal member 4.

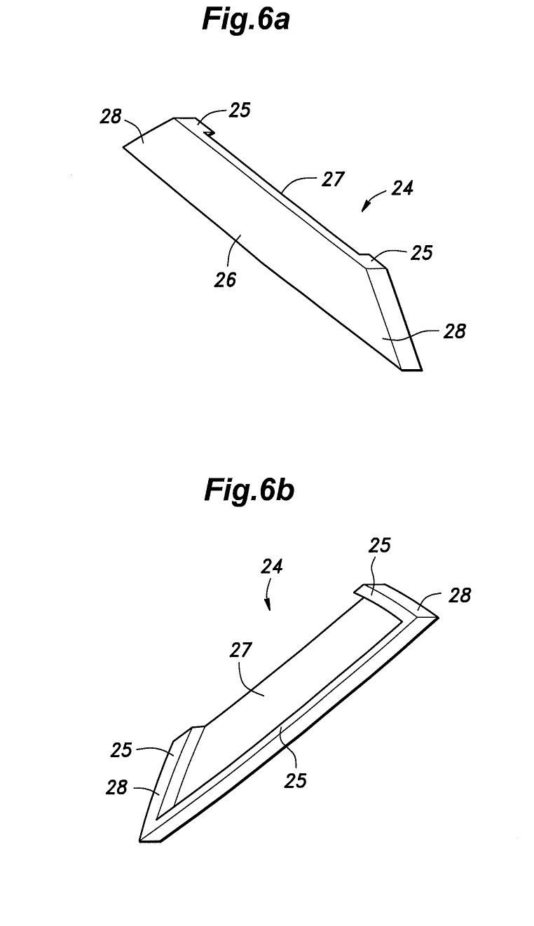

In the illustrated embodiment, the support member 24 is formed by molding plastic material, and extends laterally along the lower edge of the second glass sheet 8 on the second surface 10 thereof. As shown in FIG. 6, the support member 24 is given with the shape of a trapezoidal plate, and is provided with a flange 25 extending perpendicularly from the lateral edges and the lower edge toward the second glass sheet 8. The outboard surface of the support member 24 defines a recess 27 owing to the presence of the flange 25.

The inboard surface 26 of the support member 24 defines a generally planar surface. The height of the flange 25 is selected such that the inboard surface 26 is substantially flush with the second surface 10 of the second glass sheet 8 when the support member 24 is placed in the cutout 11, and the outboard end of the flange 25 abuts the first surface 9 of the first glass sheet 6. At the same time, the recess 27 defines a cavity 27 having an opening only in an upper end thereof jointly with the first surface 9 of the first glass sheet 6.

When the support member 24 is placed in the cutout 11, the terminal pieces 17 and the bus bars 12 are partly received in the cavity 27. More specifically, in a side view, the support member 24 partly covers the terminal pieces 17 and the bus bars 12. Thus, the support member 24 is avoided from contacting the terminal pieces 17 and the bus bars 12, and is properly positioned in the cutout 11 by the abutting of the side edges 28 thereof with the opposing edges 21 of the first glass sheet 6 defining the cutout 11 and the abutting of the flange 25 with the second surface 10 of the second glass sheet 8. In the illustrated embodiment, the side edges 28 of the support member 24 and the opposing edges 21 of the first glass sheet 6 are complementary to each other so that the abutting edges are closely in contact with each other.

When the support member 24 is placed in the cutout 11, a recess 18 is defined by the upper edge of the support member 24, the opposing edges 21 of the first glass sheet 6 and the second surface 10 of the second glass sheet 8. The terminal pieces 17 and the bus bars 12 are partly received in this recess 18, and the recess 18 is filled by a sealant 20 which may consist of any per se known sealant material such as polyurethane resin, epoxy resin, polysulfide resin and silicone resin. The sealant 20 also fixedly attaches the support member 24 to the first and second glass sheets 6 and 8. The sealant 20 may additionally fill the cavity 27 defined between the support member 24 and the second glass sheet 8. A thin layer of the sealant 20 may be present between the end of the flange 25 and the opposing surface (second surface) of the second glass sheet 8.

The sealant 20 defines an inboard surface 22 which is flush with both the first surface 9 of the first glass sheet 6 and the inboard surface 26 of the support member 24. This inboard surface 22 can be shaped by using a spatula or a mold before the sealant 20 fully cures. The sealant 20 is provided with an extension 30 which extends through a gap defined between the part of the terminal pieces 17 extending out of the cutout 11 and the first surface 9 of the first glass sheet 6, and is terminated by the two-sided tape 54 joining the terminal pieces 17 to the first surface 9 of the first glass sheet 6. This extension 30 contributes to the sealing of the interface between the edge 21 of the first glass sheet 6 and the sealant 20.

Referring to FIGS. 3 and 4, the seal member 4 consists of a plastic member insert molded around an insert member 31. The material for the seal member 4 may consist of olefin elastomer such as polyvinyl chloride, thermoplastic elastomer such as styrene elastomer, or rubber material such as ethylene-propylene-diene rubber (EPDM). Preferably, the material for the seal member 4 consists of poly(p-phenylene oxide) (PPO). The insert member 31 may consist of a resilient metallic piece such as aluminum strip.

The seal member 4 comprises a bonding portion 32 abutting the peripheral part of the first surface 9 of the first glass sheet 6 and the inboard surface 26 of the support member 24, and extending along the peripheral edge of the first glass sheet 6. The bonding portion 32 is attached to the peripheral part of the first surface 9 of the first glass sheet 6 and the inboard surface 26 of the support member 24 by using two-sided tape 33. The two-sided tape 33 is desired to have a favorable bonding property with respect to the first surface 9 of the first glass sheet 6 and the inboard surface 26 of the support member 24. The inner end of the seal member 4 extends inward beyond the inner edge of the support member 24, and slightly overlaps with the sealant 20.

The outer end of the bonding portion 32 is provided with a hook portion 35 with a convex side thereof facing inboard. The convex side of the hook portion 35 projects more inboard than the remaining part of the bonding portion 32. The hook portion 35 is provided with engagement claws 36 defining a narrow passage leading into the center of the hook portion 35. Additionally, a lip portion 38 extends from the outboard side of the base end of the hook portion 35, and abuts the peripheral edge 19 of the second glass sheet 8 under a resilient force. The free end of the lip portion 38 is substantially flush with the outboard surface of the second glass sheet 8.

The hook portion 35 engages an engagement piece 43 of a cowl top 42 which is passed into the center of the hook portion 35 via the narrow passage defined between the engagement claws 36. The engagement piece 43 is provided with a barb so that the engagement piece 43 may be relatively securely engaged by the hook portion 35. The cowl top 42 is configured to close an upper opening of a cowl box (not shown in the drawings) formed between the rear end of the engine hood (not shown in the drawings) and the lower edge of the front windscreen 1. The cowl top 42 is provided with a planar outer surface which is substantially flush with the outboard end of the lip portion 38 and the outboard surface of the second glass sheet 8.

The insert member 31 extends inside the bonding portion 32 and the hook portion 35 to maintain the shape of the hook portion 35. The insert member 31 also extends inside the lip portion 38 to maintain the shape of the lip portion 38.

As discussed earlier, each terminal piece 17 includes a base end fixedly secured to the spacer bar 16 (which is in turn attached to the inboard surface of the bonding portion 32), an intermediately part which is bent by about 180 degrees and passed into the sealant 20 in an oblique direction, and a free end which is bonded to the corresponding bus bar 12. The main cable portion 15 of the wire harness 14 extends downward from the spacer bar 16, and after being passed through a gap defined between the hook portion 35 and a vehicle panel 46, extends into an engine room (not shown in the drawings).

The method of manufacturing the front windscreen of the illustrated embodiment is described in the following. First of all is prepared the laminated glass 2 consisting of the first glass sheet 6 provided with the cutout 11 in the lower edge thereof, the second glass sheet 8 placed on the outboard side of the first glass sheet 6 via the interlayer 7, the electro-conductive strips 13 formed on the second surface 10 of the second glass sheet 8 and the bus bars 12 placed on the second surface 10 of the second glass sheet 8 so as to be partly exposed in the cutout 11. This laminated glass 2 can be obtained by forming the cutout 11 in the first glass sheet 6, forming the electro-conductive strips 13 and the bus bars 12 on the second surface 10 of the second glass sheet 8, and laminating the second glass sheet 8 onto the first glass sheet 6 via the interlayer 7 by using both heat and pressure.

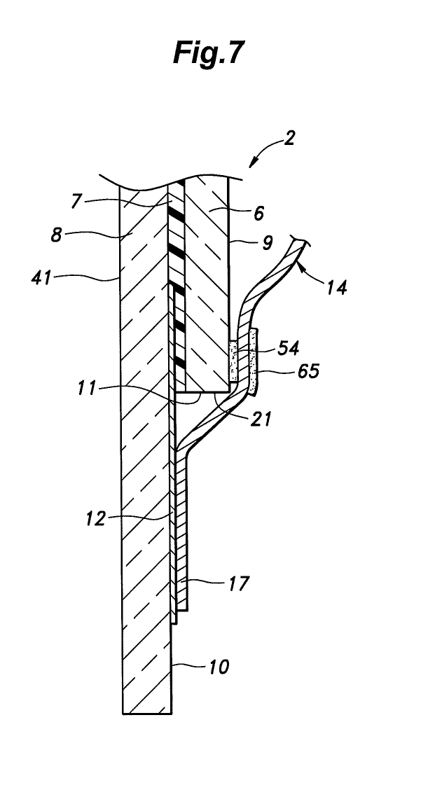

FIGS. 7 to 9 are sectional views showing the various stages of manufacturing the front windscreen. As shown in FIG. 7, the free end of each terminal piece 17 of the wire harness 14 is bonded to the corresponding bus bar 12 by soldering. At this time, the film on the terminal piece 17 is melted and removed by the heat of the soldering, and the metallic part of the terminal piece 17 is connected to the bus bar 12. The terminal piece 17 extends obliquely upward and in the inboard direction within the cutout 11, and extends beyond the edge 21 of the first glass sheet 6 defining the cutout 11 along the first surface 9 of the first glass sheet 6. This part of the terminal piece 17 is attached to the first surface 9 by using two-sided tape 54. Thereafter, masking tape 65 is applied to the part of the first surface 9 adjoining the cutout 11.

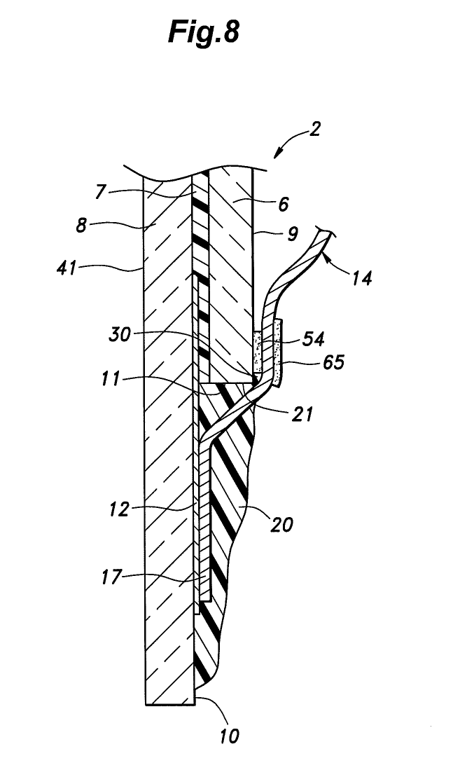

Then, as shown in FIG. 8, the sealant 20 is applied (filled into) the cutout 11 so as to completely cover the bonded parts between the bus bars 12 and the terminal pieces 17. The masking tape 65 prevents the sealant 20 from being deposited on undesired parts. As the support member 24 is to be placed in the cutout 11 in the subsequent manufacturing step, the amount of the sealant 20 is adjusted so that the combined volume of the support member 24 and the sealant 20 is slightly greater than the volume of the cutout 11. Preferably, the sealant 20 is filled into the cutout 11 in such a manner that no void is created between each terminal piece 17 and the opposing edge 21 of the cutout 11 and between each terminal piece 17 and the opposing first surface 9 of the first glass sheet 6. As a result, the sealant 20 forms the extension 30 which extends beyond the edge of the cutout 11 along the first surface 9 up to the abutting edge of the two-sided tape 54.

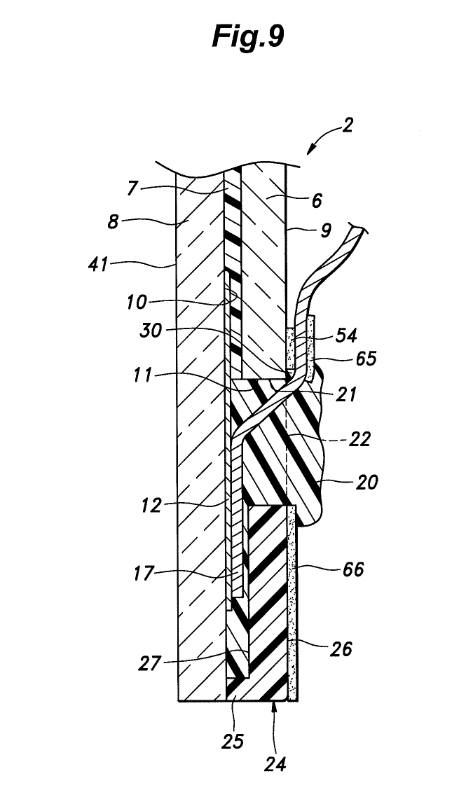

Referring to FIG. 9, before the sealant 20 has fully cured, the support member 24 is installed in the cutout 11. Before installing the support member 24 in the cutout 11, it is desirable to apply masking tape 66 onto the inboard surface 26 of the support member 24. As the support member 24 is installed in the cutout 11, a part of the sealant 20 is displaced by the support member 24. Once the front end of the flange 25 of the support member 24 has come into contact with the second surface 10, and the lateral edges of the support member 24 are pushed against the opposing edge 21 of the first glass sheet 6 defining the cutout 11, the inboard surface 26 of the support member 24 is flush with the first surface 9. As the support member 24 is installed in the cutout 11 while displacing the sealant 20 in the cutout 11, the support member 24 fills the cutout 11 in cooperation with the sealant 20 without leaving any void in the cutout 11.

Owing to the presence of the support member 24 within the cutout 11, the sealant 20 that is displaced by the support member 24 is pushed out inboard beyond the first surface 9. Any excess sealant 20 that is pushed out of the cutout 11 is removed by using a spatula or the like so that the inboard surface 22 of the sealant 20 is flush with the first surface 9. The inboard surface 22 of the sealant 20 may be adjusted such that the inboard surface of the sealant slightly protrudes more inboard than the first surface 9 by taking into account the shrinkage of the sealant 20 owing to the curing thereof. The excess sealant that may seep onto the first surface 9 and the inboard surface 26 of the support member 24 can be removed by peeling off the masking tape 65 and 66.

After the sealant 20 has cured, and the support member 24 is thereby fixedly attached to both the first glass sheet 6 and the second glass sheet 8, the seal member 4 is attached to the peripherally part of the laminated glass sheet 2 by bonding the bonding part 32 of the seal member 4 to the inboard surface 27 of the support member 24 by using two-sided tape 33 such that the lip portion 38 engages the peripheral edge of the second glass sheet 8. The terminal pieces 17 are bent back by about 180 degrees, and the spacer bar 16 is bonded to the inboard side of the bonding portion 32 of the seal member 4 by using two-sided tape 45. As a result, the front windscreen 1 is completed as shown in FIG. 3.

The functionalities and advantages of the front windscreen 1 are discussed in the following. In the illustrated embodiment, the cutout 11 is formed in the first glass sheet 6 so that the bus bars 12 are exposed or placed in accessible condition before the sealant 20 is applied. Therefore, the wire harness 14 can be connected to the bus bars 12 after the laminated glass sheet 2 is formed by the first glass sheet 6, the interlayer 7 and the second glass sheet 8. In the illustrated embodiment, as the sealant 20 that is filled into the cutout 11 completely covers the parts of the terminal pieces 17 of the wire harness 14 that are bonded to the bus bars 12, these parts of the terminal pieces 17 are not only mechanically reinforced but also effectively sealed against moisture and other substances that may otherwise corrode these parts.

As the bonding portion 32 of the seal member 4 is bonded to the smooth inboard surface 26 of the support member 24, a reliable attachment of the seal member 4 to the laminated glass sheet 2 can be achieved. As the support member 24 abuts the second surface 10 of the second glass sheet 8 via the flange 25 thereof, the inboard surface 26 of the support member 24 can be accurately positioned flush with the first (inboard) surface 9 of the first glass sheet 6. Therefore, no gap is created between the inboard surface 26 of the support member 24 or the first surface 9 of the first glass sheet 6 and the opposing side of the two-sided tape 33 particularly adjacent to the lateral side edges 28 of the support member 24 so that a reliable bonding by the two-sided tape 33 can be achieved. Also, the fact that the lateral side edges 28 of the support member 24 abut the opposing edges 21 of the cutout 11 contributes to the reliable bonding by the two-sided tape 33.

The support member 24 is provided with a recess 27 that receives the bus bars 12 and the corresponding parts of the terminal pieces 17 so that these parts can be placed within the cutout 11 without interfering with the support member 24. Therefore, even when the volume of the cutout 11 is relatively small, the support member 24 can be easily placed in the cutout 11 without interfering with the bus bars 12 and the associated parts of the terminal pieces 12. Furthermore, the presence of the flange 25 contributes to the secure bonding between the support member 24 and the sealant 20.

Although the present invention has been described in terms of preferred embodiments thereof, it is obvious to a person skilled in the art that various alterations and modifications are possible without departing from the scope of the present invention which is set forth in the appended claims. For instance, the deicer 3 consisting of the bus bars 12, the electro-conductive strips 13 and the wire harness 14 are provided on the laminated glass 2, other electric devices such a de-fogger and a printed antenna can also be incorporated in the laminated glass sheet 2, instead of a deicer.

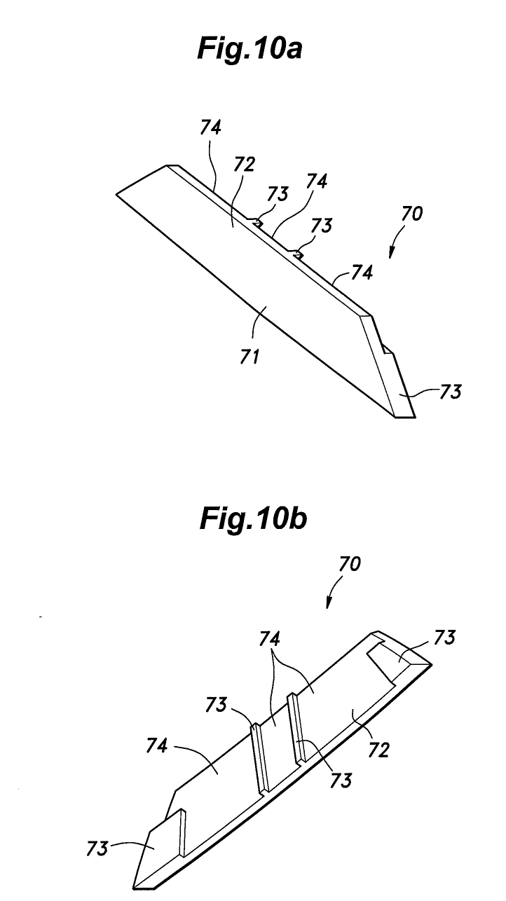

The shape of the support member 24 is not limited by that of the illustrated embodiment, but may take various other forms. FIG. 10 shows such a modified embodiment of the support member. This support member 70 is provided with an outer profile similar to that of the first embodiment so as to be fit closely into the cutout 10 and a planar inboard surface 71. The opposite surface of the support member 70 is provided with a pair parallel vertical ribs 73a and a pair of projections 73b that are provided on either lateral end of the support member 70. These ribs 73a and projections 73b are provided with a same height so that the inboard surface 71 is flush with the first surface 9 of the first glass sheet 6 when the support member 70 is received in the cutout 11. The bust bars 12 and the corresponding parts of the terminal pieces 17 are received in recesses formed by the ribs 73a and projections 73b, and the ribs 73 effectively separates the bus bars 12 from one another.

In the foregoing embodiment, the two-sided tape 33 was bonded only to the inboard surface 26 of the support member 24, but may also be additionally bonded to the inboard surface of the sealant 20 or may also be bonded only to the inboard surface of the sealant 20.

The contents of the original Japanese patent application on which the Paris Convention priority claim is made for the present application as well as the contents of the prior art references mentioned in this application are incorporated in this application by reference.

1. An automotive glazing, comprising a laminated glazing sheet including a first glazing sheet and a second glazing sheet laminated to an outboard side of the first glazing sheet, and a seal member attached to a peripheral part of the laminated glazing sheet, the automotive glazing further comprising:
a cutout formed in a peripheral part of the first glazing sheet;
an electro-conductive pattern formed on an inboard side of the second glazing sheet;
electrode pieces connected to parts of the electro-conductive pattern and placed on the inboard side of the second glazing sheet within the cutout of the first glazing sheet;
flexible terminal pieces bonded to the corresponding electrode pieces; and
a cover member placed in the cutout so as to at least partly cover the electrode pieces and associated parts of the terminal pieces and defining an inboard surface substantially flush with an inboard side of the first glazing sheet;
wherein the seal member is bonded to a peripheral part of the inboard side of the first glazing sheet and the inboard surface of the cover member, and the terminal pieces are drawn from the electrode pieces out of the cutout via the cover member.

2. The automotive glazing according to claim 1, wherein the terminal pieces are drawn from the electrode pieces out of the cutout via a part of the cover member adjacent to an edge of the first glazing sheet defining the cutout.

3. The automotive glazing according to claim 1, wherein the terminal pieces include free end parts bonded to the corresponding electrode pieces and drawn away from an adjoining peripheral part of the second glazing sheet, and base end parts bent back toward the peripheral part of the second glazing sheet and extending along an inboard side of the seal member.

4. The automotive glazing according to claim 3, wherein parts of the terminal pieces drawn out from the cutout are bonded to an inboard side of the first glazing sheet before being bent back.

5. The automotive glazing according to claim 1, wherein the cover member comprises a support member bonded to the inboard side of the second glazing sheet and defining the inboard surface of the cover member, and a sealant covering parts of the terminal pieces that are connected to the electrode pieces.

6. The automotive glazing according to claim 5, wherein the support member comprises a projection abutting the inboard side of the second glazing sheet and a recess defining a gap between a main part of the support member and the inboard side of the second glazing sheet, at least parts of the electrode pieces and the terminal pieces being placed in the gap defined between the main part of the support member and the inboard side of the second glazing sheet.

7. The automotive glazing according to claim 6, wherein the support member includes an outer edge extending along a peripheral edge of the second glazing sheet, a pair of lateral edges abutting respective lateral edges of the first glazing sheet defining the cutout and an inner edge spaced from an opposing edge of the first glazing sheet defining the cutout.

8. The automotive glazing according to claim 7, wherein a gap defined between the inner edge of the support member and the opposing edge of the first glazing sheet is at least partly filled by the sealant.

9. The automotive glazing according to claim 8, wherein an inboard surface of the sealant filling the gap defined between the inner edge of the support member and the opposing edge of the first glazing sheet is substantially flush with the inboard surface of the support member and the inboard side of the first glazing sheet.

10. The automotive glazing according to claim 5, wherein the seal member includes a bonded part which is bonded to the peripheral part of the inboard side of the first glazing sheet and the inboard surface of the support member.

11. The automotive glazing according to claim 10, wherein the terminal pieces are fixedly attached to a spacer bar which is in turn bonded to an inboard side of the bonded part of the seal member.

12. A method of manufacturing an automotive glazing, comprising the steps of:
preparing a laminated glazing sheet including a first glazing sheet having a cutout formed in a peripheral part thereof, a second glazing sheet laminated to an outboard side of the first glazing sheet, an electro-conductive pattern formed on an inboard side of the second glazing sheet, electrode pieces connected to parts of the electro-conductive pattern and placed on the inboard side of the second glazing sheet within the cutout of the first glazing sheet;
bonding an end of a flexible terminal piece to each of the electrode pieces, and drawing another end of the terminal piece out of the cutout;
depositing a sealant in the cutout so as to at least partly cover the electrode pieces and corresponding parts of the terminal pieces;
placing a support member in the cutout before the sealant has cured such that the support member defines a support surface substantially flush with the inboard side of the first glazing sheet; and
attaching a seal member to an inboard side of a peripheral part of the first glazing sheet and the support surface of the support member.
